(19) United States
(12) Patent Application Publication
(10) Pub. No.: US 2010/0129610 A1
(43) Pub. Date: May 27, 2010

(54) PRISMATIC SILICON AND METHOD OF PRODUCING SAME

(75) Inventors: Fumikazu Oohira, Takamatsu (JP); Gen Hashiguchi, Takamatsu (JP); Shinya Nagao, Takamatsu (JP)

Correspondence Address: Weaver Austin Villeneuve & Sampson LLP, P.O. BOX 70250, OAKLAND, CA, 94612-0250, US

(73) Assignee: NATIONAL UNIVERSITY CORPORATION KAGAWA UNIVERSITY, Takamatsu, Kagawa (JP)

(21) Appl. No.: 12/530,063

(22) PCT Filed: May 14, 2007
(86) PCT No.: PCT/JP2007/060298

§ 371 Date: Sep. 4, 2009

(30) Foreign Application Priority Data
Mar. 16, 2007 (JP) 2007-067708

(51) Int. Cl. B32B 3/30; C23F 1/00

(52) U.S. Cl. 428/167; 216/99; 216/37

(57) ABSTRACT

Silicon in prismatic shape is produced by using a silicon wafer with (110) surface and sequentially carrying out an alignment configuration forming step for forming alignment configurations having surfaces that are along two (111) surfaces perpendicular to a substrate surface inside the silicon wafer, a primary anisotropic etching step for forming perpendicular walls having wall surfaces aligned to one of these (111) surfaces, and a secondary anisotropic etching step for forming silicon in the prismatic shape having wall surfaces aligned to the other of these (111) surfaces with respect to the perpendicular walls.

This application is a continuation of International Application No. PCT/JP2007/060298, filed May 14, 2007 which claims priority on Japanese Patent Application 2007-067708 filed Mar. 16, 2007.

### BACKGROUND OF THE INVENTION

This invention relates to prismatic silicon and a method of producing the same.

Crystalline anisotropic etching is one method of fabricating a silicon wafer. This is a method of etching a wafer into a specified shape by making use of the property of certain etching solutions, such as KOH, allowing the etching reaction to proceed in a certain crystalline direction but significantly less in certain other directions.

A silicon wafer is obtained by slicing a silicon crystal ingot into a planar form but its single crystals are of a diamond structure. The crystal surfaces of single crystal silicon include (100), (110) and (111) surfaces and various researches have been carried out according to these various crystal surfaces.

Most of the researches on anisotropic etching of silicon have been regarding the (100) substrates. If anisotropic etching is done on a silicon (100) substrate by appropriately using a resist or the like for patterning, for example, pyramid-shaped grooves are formed with (111) surfaces as their side surfaces. Examples of the etching technologies on the (100) surface include DNA nano-tweezers, sockets for micro-connectors and sensor devices, making use of the property that a triangular shape can be thereby formed. Indeed, most of the researches on anisotropic etching of silicon have been on the (100) substrates.

It is known that perpendicular grooves having the (111) surfaces as the side surfaces are formed if anisotropic etching is carried out on the (110) surface, which is different from the (100) surface. Since a shape with perpendicular walls can be formed, there have been reports on researches on the production of half mirrors, etalons and micro-minors by using such perpendicular wall surfaces (such as Japanese Patent Publication Tokkai 8-90431; Y. Uenishi, M. Tsugai and M. Mehegny, “Micro-opto mechanical devices fabricated by anisotropic etching of (100) silicon”, Proc. IEEE Micro Electro Mechanical Systems Workshop, Oiso, Japan 319-324 (1994); and Y. Uenishi, M. Tsugai and M. Mehegny, “Micro-opto mechanical devices fabricated by anisotropic etching of (100) silicon”, J. Micromech. Microeng., Vol. 5, 305-312 (1995)).

As described above, most of the conventional silicon fabrication technologies using crystalline anisotropic etching related to objects making use of a pyramid-like shape or having grooves with perpendicular walls or perpendicular wall surfaces. By contrast, there has been no technology developed for fabricating silicon in a prismatic shape and no such method of fabrication has been known.

In view of the situation as described above and with the idea that silicon in a prismatic shape would be useful in hitherto unconsidered ways in various industrial areas such as fabrication of mother dies for filters and high-density micro-electrodes, the present inventors have accomplished the present invention by diligently conducting researches on the technology of fabricating silicon in a prismatic shape having a high aspect ratio.

### SUMMARY OF THE INVENTION

On the basis of conventional methods of fabricating the (110) surface of silicon, it may be considered possible to obtain silicon in a prismatic shape by patterning a silicon (110) substrate with squares of a resist and carrying out an anisotropic etching process, but it is in reality not so. This is because when the (111) surfaces cross each other, the bottom point where they cross at valleys can function as an etch stop but the top of hills cannot function as such. Accordingly, a new theory for the fabrication process other than by simple patterning has been considered necessary.

In view of the above, it is an object of this invention to provide a method of producing prismatic silicon based on a completely new technical principle, and it is another object of this invention to provide prismatic silicon with a high aspect ratio.

A method (hereinafter also referred to as the first production method) according to this invention is characterized as using a silicon wafer with (110) surface for producing silicon in a prismatic shape and as comprising sequentially carrying out an alignment configuration forming step for forming alignment configurations having surfaces that are along two (111) surfaces perpendicular to a substrate surface inside the silicon wafer, a primary anisotropic etching step for forming perpendicular walls having wall surfaces aligned to one of these (111) surfaces, and a secondary anisotropic etching step for forming silicon in the prismatic shape having wall surfaces aligned to the other of these (111) surfaces with respect to the perpendicular walls.

By a production method as described above, silicon prisms having (110) surface as the top surface and (111) surfaces as the side surfaces can be obtained because a silicon wafer with (110) surface is employed and the etching processes are carried out such that two internal (111) surfaces perpendicular to the substrate surface will come to be exposed. It is also made possible by such a production method to dig out perpendicular (111) surfaces accurately and hence to obtain silicon prisms with side walls that are accurately perpendicular to the top surface since the etching processes include both the primary anisotropic etching which is carried out after alignment configurations are formed with two perpendicular (111) by aligning according to one of the (111) surfaces and the secondary anisotropic etching according to the other of the (111) surfaces.

Another method (hereinafter also referred to as the second production method) according to this invention is characterized as using a silicon wafer with (110) surface for producing silicon in a prismatic shape and as comprising sequentially carrying out an alignment configuration forming step for forming alignment configurations having surfaces that are along two (111) surfaces perpendicular to a substrate surface inside the silicon wafer, a primary anisotropic etching step for forming perpendicular walls by carrying out an anisotropic etching process on the silicon wafer with resist patterning aligned to one of these (111) surfaces such that this one (111) surface becomes a perpendicular wall surface, a protective film forming step for forming a protective film on surfaces of the silicon wafer inclusive of the wall surface of the perpendicular walls, and a secondary anisotropic etching step for forming silicon in the prismatic shape by carrying out an anisotropic etching process on the silicon wafer with resist patterning aligned to the other of these (111) surfaces such that portions of the perpendicular walls become the other (111) surface and a perpendicular wall surface.

This production method, including the alignment configuration forming step, the primary anisotropic etching step and the secondary anisotropic etching step, has all the advantages of the first production method. By this production method as descried above, furthermore, the protective film can be attached to the side walls of the perpendicular walls formed by the primary isotropic etching and the side walls can be prevented from being abraded at the time of the secondary isotropic etching since the protective film forming step is inserted between the primary isotropic etching and the secondary isotropic etching. As a result, only the surface crossing the side walls having the protective film is subjected to the etching process at the secondary isotropic etching and the prisms are completed when the etch stop is effected at the (111) surface of the side wall. Thus, it becomes possible to obtain silicon prisms having four accurately perpendicular (111) surfaces as side surfaces and theoretically having a high aspect ratio.

A third method according to this invention is characterized as using a silicon wafer with (110) surface for producing silicon in a prismatic shape and as comprising sequentially carrying out an alignment configuration forming step for forming alignment configurations having surfaces that are along two (111) surfaces perpendicular to a substrate surface inside the silicon wafer, a pattern forming step for forming a first resist pattern along one of these (111) surfaces and a second resist pattern on the first resist pattern along the other of said (111) surfaces, a primary anisotropic etching step for forming perpendicular wall surfaces to the first resist pattern by digging on the silicon wafer between mutually adjacent ones of the first resist pattern by anisotropic etching, a protective film forming step for forming a protective film entirely over the silicon wafer inclusive of the wall surfaces of the perpendicular walls, a cutting step for cutting a silicon surface underneath the second resist pattern on the perpendicular walls, and a secondary anisotropic etching step for forming silicon in the prismatic shape having a portion with the first resist pattern as top surface by digging on the silicon wafer by crystalline anisotropic etching.

Silicon in a prismatic shape (or a silicon prism) according to this invention is characterized as having a (110) surface as a top surface and four side surfaces that are (111) surfaces and perpendicular to this top surface. Such a silicon prism may be further characterized as being produced by any of the production methods of this invention as characterized above.

This production method, including the alignment configuration forming step, the primary anisotropic etching step and the secondary anisotropic etching step, has all the advantages of the first production method. By this production method as descried above, furthermore, no particular method is necessary for the coating of resist or for the exposure to light because the protective film forming step can be carried out prior to the formation of the perpendicular walls while the silicon surface is still flat. Moreover, the protective film can be attached to the side walls of the perpendicular walls formed by the primary anisotropic etching step since it is formed between the primary and secondary anisotropic etching steps. The side walls can thus be prevented from being abraded at the time of the secondary anisotropic etching. As a result, only the portions not having the protective film are etched in the secondary anisotropic etching step and the prismatic shapes are formed at the moment of the etch stop at the (111) surface of these side walls. Thus, silicon prisms having four accurately perpendicular (111) surfaces as side walls can be obtained.

Silicon in a prismatic shape (or silicon prism) of this invention is characterized as having a (110) surface as a top surface and four side surfaces that are (111) surfaces and perpendicular to said top surface. It has a prism-shape with no burrs or chipping. Thus, prisms with a high aspect ratio are possible and can be useful in many applications. Such silicon prisms of this invention can be produced by any of the production methods of this invention and can have a high aspect ratio and hence are usable in many applications requiring such a high aspect ratio.

### BRIEF DESCRIPTION OF THE DRAWINGS

FIG. 1A, FIG. 1B and FIG. 1C, together referred to as FIG. 1, are respectively the first, second and third steps of the first production method according to this invention.

FIG. 2A, FIG. 2B and FIG. 2C, together referred to as FIG. 2, are respectively the fourth, fifth and sixth steps of the first production method according to this invention.

FIG. 3A, FIG. 3B and FIG. 3C, together referred to as FIG. 3, are respectively the seventh, eighth and ninth steps of the first production method according to this invention.

FIG. 4A, FIG. 4B and FIG. 4C, together referred to as FIG. 4, are respectively the tenth, eleventh and twelfth steps of the first production method according to this invention.

FIG. 5A, FIG. 5B and FIG. 5C, together referred to as FIG. 5, are respectively the first, second and third steps of the second production method according to this invention.

FIG. 6A, FIG. 6B and FIG. 6C, together referred to as FIG. 6, are respectively the fourth, fifth and sixth steps of the second production method according to this invention.

FIG. 7A, FIG. 7B and FIG. 7C, together referred to as FIG. 7, are respectively the seventh, eighth and ninth steps of the second production method according to this invention.

FIG. 8A, FIG. 8B and FIG. 8C, together referred to as FIG. 8, are respectively the tenth, eleventh and twelfth steps of the second production method according to this invention.

FIG. 9A, FIG. 9B and FIG. 9C, together referred to as FIG. 9, are respectively the thirteenth, fourteenth and fifteenth steps of the second production method according to this invention.

FIG. 10A, FIG. 10B and FIG. 10C, together referred to as FIG. 10, are respectively an explanatory diagram of alignment configurations, an enlarged plan view and an enlarged sectional view of an alignment configuration.

FIG. 11A is a sectional view of perpendicular walls, and FIG. 11B is a diagonal view of silicon prisms as they are formed.

FIG. 12A is a sectional view of a situation if incisions were not made in the second production method of this invention, FIG. 12B is a sectional view if an incision is made according to the second production method of this invention, and FIG. 12C is a sectional view after the second anisotropic etching step.

FIG. 13 is an SEM (scanning electron microscopy) photograph of prisms formed after the secondary anisotropic etching step was carried out for 30 minutes.

FIG. 14 is an SEM photograph of prisms formed after the secondary anisotropic etching step was carried out for one hour.

FIG. 15 is an SEM photograph of prisms formed after the secondary anisotropic etching step was completed and the oxide films were removed.

FIG. 16 is an enlarged photograph of a portion of FIG. 15.

FIG. 17 is a drawing for explaining the orientation of the crystalline surfaces of a silicon wafer.

### DETAILED DESCRIPTION OF THE INVENTION

Embodiments of this invention are explained next with reference to the drawings.

This invention is based on the technical principle of using the (111) surfaces inside a (110) silicon wafer perpendicular to the substrate surface for forming a prismatic shape with a high aspect ratio having side walls perpendicular to the top (110) surface. The position of the (111) surface of a (110) silicon wafer is known to be as shown in FIG. 17, the arrow therein representing a normal line vector to the surface. FIG. 17 shows that the (111) surfaces of a (110) silicon wafer include both portions perpendicular to the (110) surface and portions inclined with respect thereto. It is also seen that two of the perpendicular (111) surfaces make an angle of 109.5° between them. The present invention is characterized as using the etching characteristics due to the crystalline anisotropy and using these two perpendicular (111) surfaces to form a prismatic shape with a high aspect ratio.

The silicon wafer to be used according to this invention is a wafer sliced from an ingot such that its surface will be a (110) surface.

The invention includes the following two methods, which are herein referred to as the first method and the second method.

The first method of this invention is explained next. This method includes the following twelve steps (Steps 1-12), Steps 1, 2 and 3 being alignment configuration forming steps, Steps 4, 5 and 6 being primary anisotropic etching steps, Steps 7 and 8 being protective film forming steps and Steps 11 and 12 being secondary anisotropic etching steps.

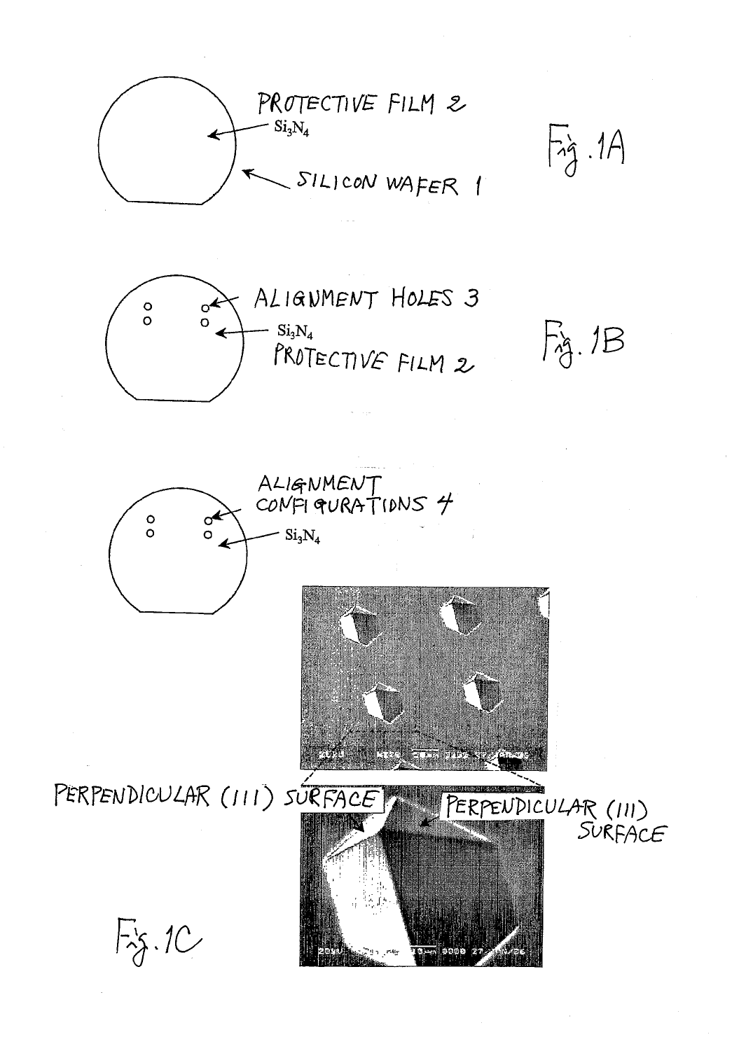

Step 1 is for forming a protective film. As shown in FIG. 1A, a protective film 2 which will serve as a mask at the time of crystalline anisotropic etching is formed all over a silicon wafer 1.

Step 1 is not only for forming alignment configurations which is carried out in Step 2 to be described below but also for preventing the perpendicular walls from melting at the time of crystalline anisotropic etching in Step 6.

For the formation of the film in this step, Si₃N₄ and SiO₂ may be used together with any known CVD method.

Si₃N₄ is considered optimal for the formation of alignment configurations and perpendicular walls. Representative examples of etching liquid for use in crystalline anisotropic etching include KOH and TMAH (tetramethyl ammonium hydroxide, or (CH₃)₄NOH). Either of these solutions may be used for anisotropic etching but a choice between Si₃N₄ and SiO₂ must be made as the mask material, depending on which of these solutions is used. Si₃N₄ is extremely hard to dissolve in KOH and TMAH and hence will not be depleted during an etching process, making it easy to control the film thickness by time management. If KOH is used, on the other hand, SiO₂ has a large etching speed and hence the time management is difficult for controlling the film thickness but may be used as a mask material if a film with a sufficient thickness is formed.

Step 2 is for preparing the formation of alignment configurations.

As shown in FIG. 1B, circular openings as alignment holes 3 are formed through the protective film 2 (such as of Si₃N₄) formed in Step 1. Step 2, having no particular limitation, may be carried out, for example, by continuing reactive ion etching (RIE) until the silicon surface comes to appear and removing the resist with a heated mixture of sulfuric acid and hydrogen peroxide water.

The positions and number of the alignment holes 3 are arbitrary, provided that they are located so as to be visible by a microscope at the time of mask alignment. If a mask aligner allowing the entire surface of the wafer 1 to be visible is used, these holes 3 may be located at any places. Their number is totally arbitrary. Although FIG. 1B shows four of them in two rows, it is not intended to limit the scope of the invention. If they are sufficiently separated, however, the accuracy of alignment can be improved.

Step 3 is for forming alignment configurations. As shown in FIG. 1C, alignment configurations 4 are formed on the silicon surface below the holes 3 formed in Step 2. This is done by crystalline anisotropic etching. For example, TMAH in an appropriate container is heated to about 60° C.-80° C. and the wafer is soaked inside and etched. FIG. 1C also includes SEM photographs of alignment configurations 4 thus produced.

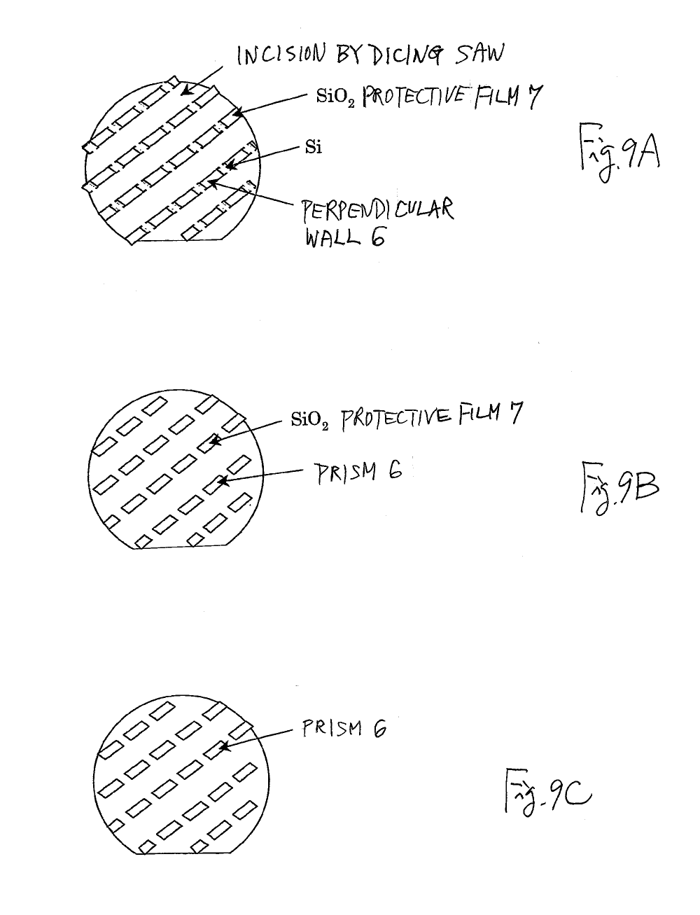

As shown also in FIG. 10A, these alignment configurations 4 are formed as indentations on the silicon surface below the protective film 2. As more clearly shown in FIG. 10B, they are hexagonal in shape, and they are indentations in a triangular shape, as shown in 10C. Explained more in detail, each alignment configuration has two mutually perpendicularly crossing (111) surfaces. These two (111) surfaces serve as references for alignment.

Step 4 is for a resist patterning according to one of the perpendicular (111) surfaces.

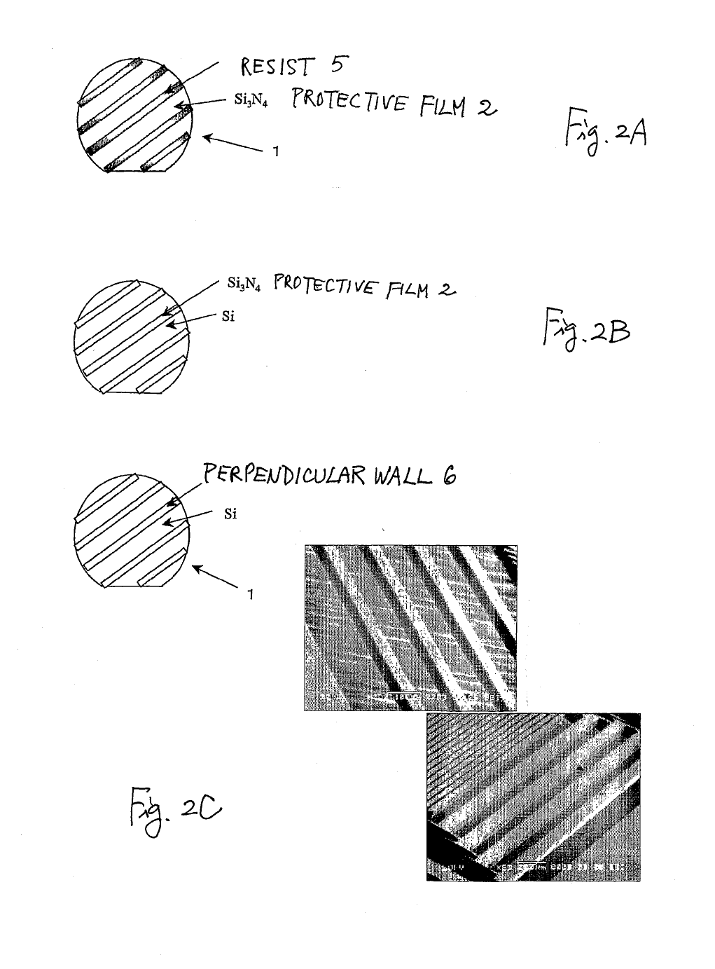

As shown in FIG. 2A, the surface of the wafer 1 is coated with a resist 5 and exposed to light for patterning a plurality of lines according to one of the perpendicular (111) surfaces of an alignment configuration. Any known resist materials such as organic resist materials may be used without any limitation as the resist 5 by any known method of application using, for example, a spin coater or a spray coater. As for the exposure to light, any known photo-etching technique may be employed.

A known device called “mask aligner” for matching the positions of a wafer and a mask may be used for aligning the resist patterning to the (111) surface of an alignment configuration 4. Since the resist patterning is very small, the positioning process with respect to the alignment configurations 4 must be carried out with a microscope being used for observation by moving the wafer in the x- and y-directions, as well as in the rotary θ-direction.

Silicon in a prismatic form is formed as will be explained below where a plurality of mutually parallel rows of such belt-like resist pattern are thus formed.

Step 5 is for removing the protective film from the silicon surface. As shown in FIG. 2B, the protective film 3 on the silicon surface is removed such that only the patterned protective film (Si₃N₄) 2 will be left. Explained more in detail, the protective film (Si₃N₄) 2 is etched by RIE to expose the silicon surface. The resist is peeled off by washing with heated sulfuric acid and hydrogen peroxide water. It is important to watch the time of etching because if RIE is used for etching, Si₃N₄ is etched and the silicon surface will come to appear before the resist disappears but if the etching is continued too long, the resist will disappear and the Si₃N₄ below the resist is also etched. After this step, the protective film 2 of Si₃N₄ is left on the top surface of the resist patterning.

Step 6 is for forming perpendicular walls by the primary anisotropic etching of the silicon surface.

As shown in FIG. 2C, crystalline anisotropic etching is carried out on the silicon wafer 1. A known etching liquid such as TMAH may be used for the etching. Since Si₃N₄ remains on the top surface portions of the protective film 2, the silicon surface adjacent to the belt-like protective film 2 portion is dug and the side surfaces of the protective film 2 portion are formed as perpendicular walls 6. This is because the surfaces of the perpendicular walls 6 are along one of the two (111) surfaces that are perpendicular to the (110) surface of the wafer. The perpendicular walls 6 thus formed are as shown in the SEM photographs of FIG. 2C. In the illustrated test example, the height of the formed perpendicular walls 6 was about 30 μm.

Step 7 is for forming a protective film on the entire surface.

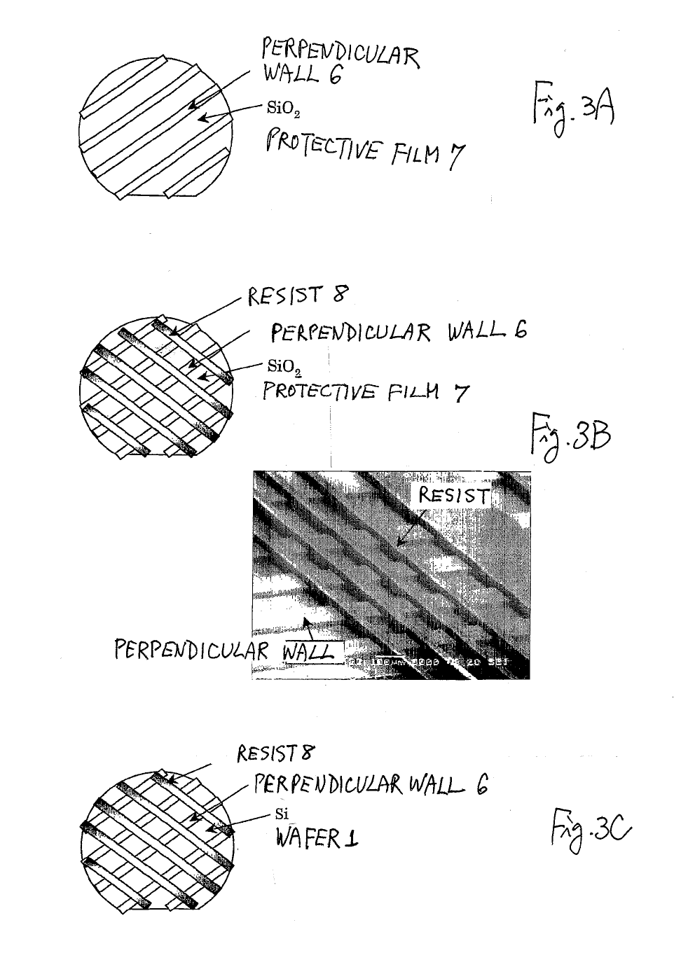

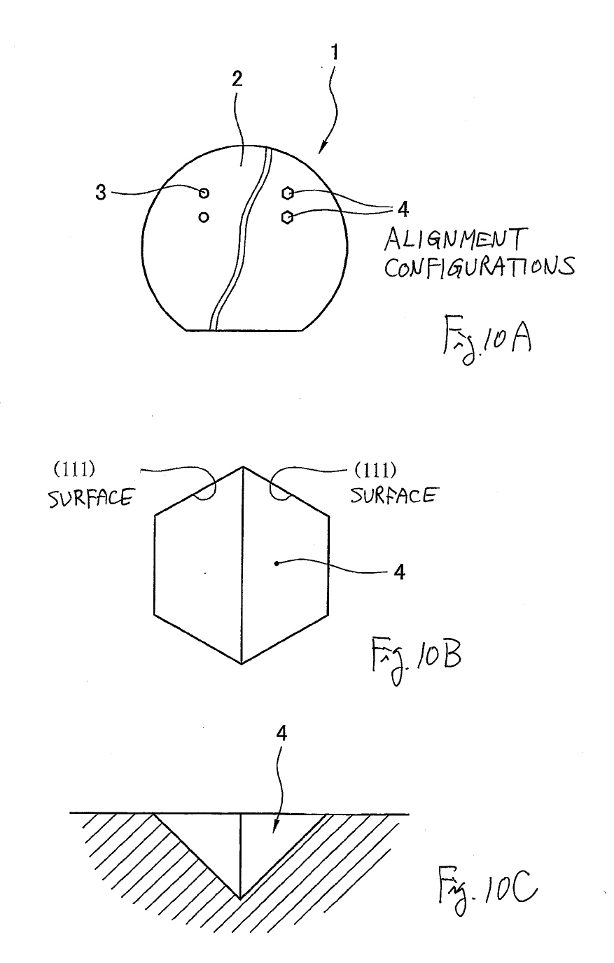

As shown in FIG. 3A, a protective film 7 is formed on the entire surface of the wafer 1 after the perpendicular walls 6 are formed. For the purpose of formation of this protective film, the wafer is, for example, thermally oxidized to form an oxide film all over its surfaces. As a result, the protective film 7 is formed as shown more clearly in FIG. 11A over all surfaces of the silicon wafer 1, inclusive of the top surfaces 6a of the perpendicular walls 6 and the side surfaces 6b. In summary, this is a step for forming a mask for the secondary anisotropic etching in Step 11 to be explained below.

Step 7 makes uses of an oxide film (SiO₂), instead of Si₃N₄. This is because the formation of an oxide film makes it easier to carry out the etching of the mask after the patterning of the resist in Step 8 to be explained below. It is permissive, however, to use Si₃N₄ or SiO₂ as the protective film 7 and to carry out the etching by RIE, and it is also possible to use Si₃N₄. It is only to be reminded that the film thickness and the kind of solution must be selected appropriately.

Any known method may be employed for the formation of the oxide film (SiO₂). For example, an oxidation furnace may be used with the internal temperature of about 1000° C. and with oxygen gas introduced therein to oxidize the wafer. The oxidation method inside the oxidation furnace includes both dry oxidation and wet oxidation. Either method may be used for the purpose of this invention. A film forming method by CVD and the so-called atmospheric pressure chemical vapor deposition (APCVD) method may be appropriately selected.

Step 8 is for resist patterning according to the other of the perpendicular (111) surfaces.

As shown in FIG. 3B, resist patterning in this step is carried out according to the other of the (111) surfaces of the alignment configuration 4.

For this purpose, the upper surface of the wafer 1 is coated with a resist 8. It is preferable to apply a thick film of resist (with thickness of about 30 μm). It is necessary to have the entire height of the perpendicular walls 11 coated. Accordingly, a thick-film resist (such as PMER and SU-8) capable of forming a thick resist is employed. As a method of coating, the spray coating method, instead of the spin coating method, may be employed because all that is necessary is to coat the entire surface. Moreover, a metallic material may be attached, instead of a resist, to use it as a mask material. Thereafter, a plurality of linear patterns are made according to the other of the perpendicular (111) surfaces. The same alignment method as used in Step 4 may be used in this step. The SEM photograph of FIG. 3B shows the appearance after the resist patterning. As a result, the oxide film 7 is left in the areas surrounded by a checkerboard pattern formed by the perpendicular walls 6 formed in Step 6 and the resist pattern formed by Step 8.

Step 9 is for removing the protective film on the silicon surface.

As shown in FIG. 3C, the oxide film 7 is etched by using the resist 8 as a mask. The etching of the oxide film is continued until the surface of the silicon wafer 1 comes to be exposed. As the method of this etching process, the wafer may be soaked in a solution of fluoric acid or use may be made of RIE. As a result of this etching process, the oxide film on the portions not protected by the resist 8 is removed from the perpendicular walls 6 and the silicon surface comes to appear. As a result, portions having the oxide film 7 attached and portions from which it has been removed are alternately formed in the longitudinal direction of the perpendicular walls 6.

Step 10 is for removing the resist and exposing the silicon surface.

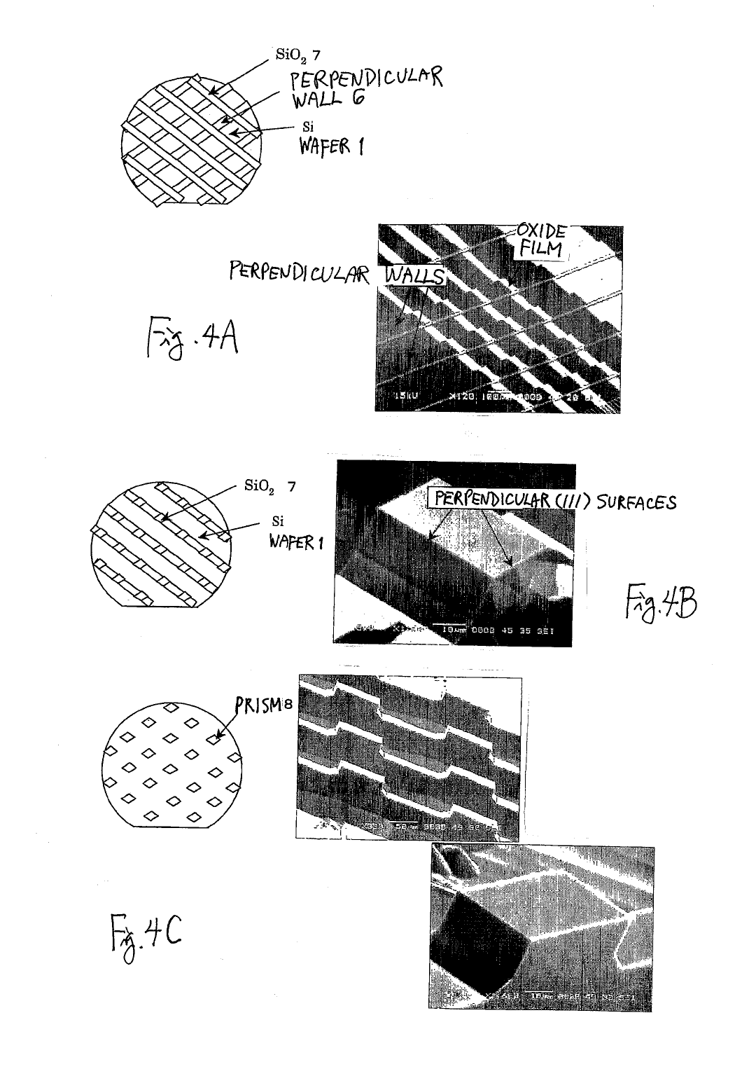

As shown in FIG. 4A, the resist 8 applied in Step 8 is now peeled off. The SEM photographs of FIG. 4A shows the peeled appearance with the oxide film 7 linearly protecting according to the other of the perpendicular (111) surfaces not only the upper surface of the perpendicular walls 6 but also their side surfaces. Moreover, the oxide film 7 exists in the longitudinal direction, having intervals. It may be seen that it is now ready to form prismatic shapes with the oxide film 7 in this condition of having intervals.

The removal of the resist is carried out as in Step 5 by using heated sulfuric acid and hydrogen peroxide water (their mixture at the ratio of 3:1). Other methods are known for the removal of a resist. Any of these known methods may be used.

Step 11 is for the secondary anisotropic etching of the silicon surface.

As shown in FIG. 4B, the oxide film 7 is used as mask to carry out the secondary anisotropic etching of the silicon wafer. TMAH, etc. may be used as the etching liquid. The method of this etching process may be the same as that for Step 6.

When the silicon surface of the wafer 1 has been dug, there is an etch stop between the perpendicular (111) surface formed earlier in Step 6 and the other of the perpendicular (111) surface (at the edge of the mask part of the top surface), there resulting silicon prisms 8.

Step 12 is for removing the protective film.

The oxide film is finally removed as shown in FIG. 4C. This may be done by using fluoric acid or by RIE. As a result of this process, the silicon prisms 8 remain standing on the silicon substrate, as shown in FIG. 11B. A plurality of silicon prisms 8 thus formed may be used as they stand on the substrate 1, or any one of them may be cut off and used for a specific purpose.

The first production method as described above has the following merits.

Firstly, silicon prisms having (110) surface as the top surface and (111) surfaces as the side surfaces can be obtained because a silicon wafer with (110) surface is employed and etching processes are carried out such that two internal (111) surfaces perpendicular to the substrate surface will come to be exposed.

Secondly, it is made possible to dig out perpendicular (111) surfaces accurately and hence to obtain silicon prisms with side walls that are accurately perpendicular to the top surface since the etching processes include both the primary anisotropic etching which is carried out after alignment configurations are formed with two perpendicular (111) surfaces by aligning according to one of the (111) surfaces and the secondary anisotropic etching according to the other of the (111) surfaces.

Thirdly, the protective film 7 can be attached to the side surfaces of the perpendicular walls 6 formed by the primary isotropic etching and the side walls can be prevented from being abraded at the time of the secondary isotropic etching since the protective film forming step is inserted between the primary isotropic etching and the secondary isotropic etching. As a result, only the surfaces crossing the side walls having the protective film are subjected to the etching process at the secondary isotropic etching and the prisms 8 are completed when the etch stop is effected at the (111) surface of this side wall. Thus, it becomes possible to obtain silicon prisms 8 having four accurately perpendicular (111) surfaces as side surfaces and theoretically having a high aspect ratio.

The silicon prisms 8 obtained by the first method according to this invention are of a prismatic shape, being surrounded by four perpendicular (111) surfaces. The height of the silicon prisms produced experimentally according to this method was about 30 μm but it should be possible in principle to obtain shapes with higher aspect ratios.

Each of the four side surfaces comprising a (111) surface means that the atomic combination is very stable and that the rigidity against external forces is very strong. Thus, even if silicon is obtained in a prismatic shape with a large height with respect to its cross-sectional area, or with a high aspect ratio, it can be used in many practical applications. Since it is formed along the crystalline surfaces of four atoms on the side surfaces, it becomes very smooth. For this reason, it can be used in various ways by making use of its prismatic shape.

Next, the second production method according to this invention will be explained.

The second production method is characterized in that incisions are made on the perpendicular walls after they are formed but it is based on the same idea regarding the crystalline orientations as the first production method. This method is advantageous because patterning is possible on wafers without resist patterning, that is, wafers without high steps formed thereon and hence the process is very simple.

Fifteen steps (Steps 1-15) are sequentially carried out according to the second production method, Steps 1, 2 and 3 being alignment configuration forming steps, Steps 4-9 being protective film forming steps, Step 10 being a primary anisotropic etching step, Steps 11 and 12 being protective film forming steps, Step 13 being a cutting step, and Steps 14 and 15 being secondary anisotropic etching steps. Steps 1-5 are the same as explained above for the first production method and hence detailed explanations will be omitted, the explanations being given only in a simple manner with like or equivalent components indicated by the same numerals as used in the description of the first production method.

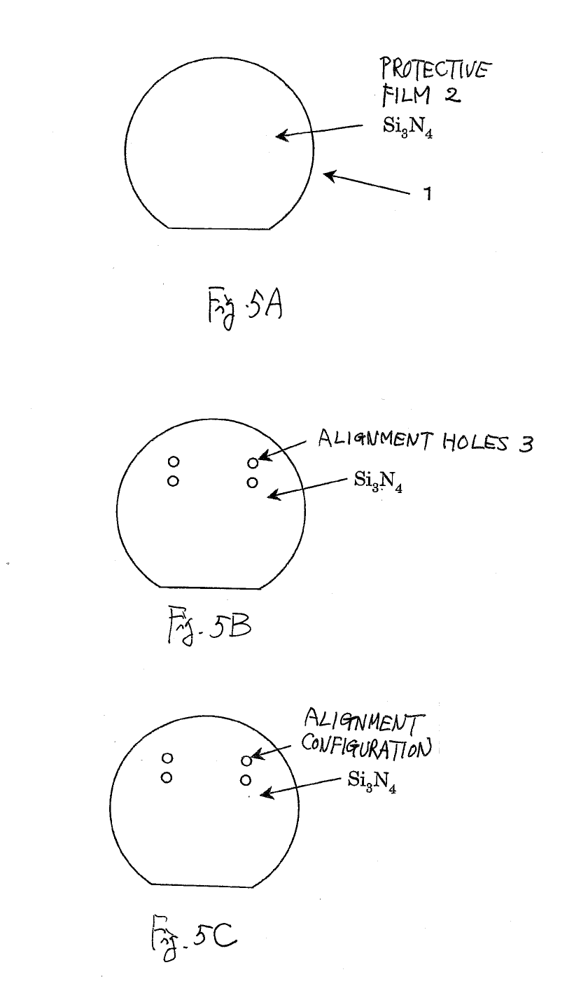

Step 1 is for forming a protective film. As shown in FIG. 5A, a protective film 2 is formed all over the surfaces of a silicon wafer 1. This protective film 2 is to serve as a mask at the time of forming alignment configurations in Step 2 and the primary anisotropic etching in Step 10 and may be obtained, for example, by a method of LPCVD using Si₃N₄.

Step 2 is for preparing to form alignment configurations. As shown in FIG. 5B, alignment holes 3 are formed through the Si₃N₄ of the protective film 2 by etching.

Step 3 is for forming alignment configurations. As shown in FIG. 5C, crystalline anisotropic etching is carried out with RMAH to form alignment configurations by etching on the silicon surface under the protective film 2. These alignment configurations are hexagonal indentations, as shown in FIG. 10, having two mutually perpendicular (111) surfaces formed therein.

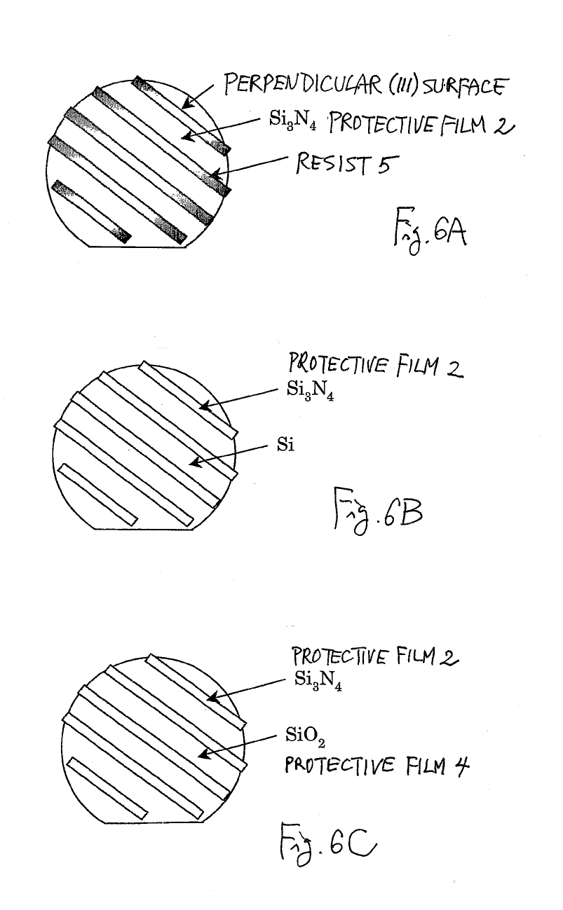

Step 4 is for a resist patterning according to one of the perpendicular (111) surfaces. As shown in FIG. 6A, the surface of the wafer 1 is coated with a resist 5 for patterning a plurality of lines according to one of the perpendicular (111) surfaces of an alignment configuration. The alignment method is the same as in the first production method.

Step 5 is for removing the protective film from the silicon surface. As shown in FIG. 6B, the protective film (Si₃N₄), formed in Step 1, is removed by etching such that the silicon surface becomes exposed where there is no resist 5.

Step 6 is for forming a protective film on the entire surface. The primary anisotropic etching step of the first production method described above is not carried out according to the second production method. Instead, as shown in FIG. 6C, the resist which was used in the previous step is peeled off, and then an oxide film is formed all over the silicon wafer as a protective film 4. Since the Si₃N₄ protective film is patterned in a belt-like manner in Step 5, the belt-like portions with Si₃N₄ are not oxidized, and the protective film 4 (SiO₂) is formed only on the silicon surface. The protective film 4 thus formed in Step 6 will serve as mask material when perpendicular walls are formed later in Step 10.

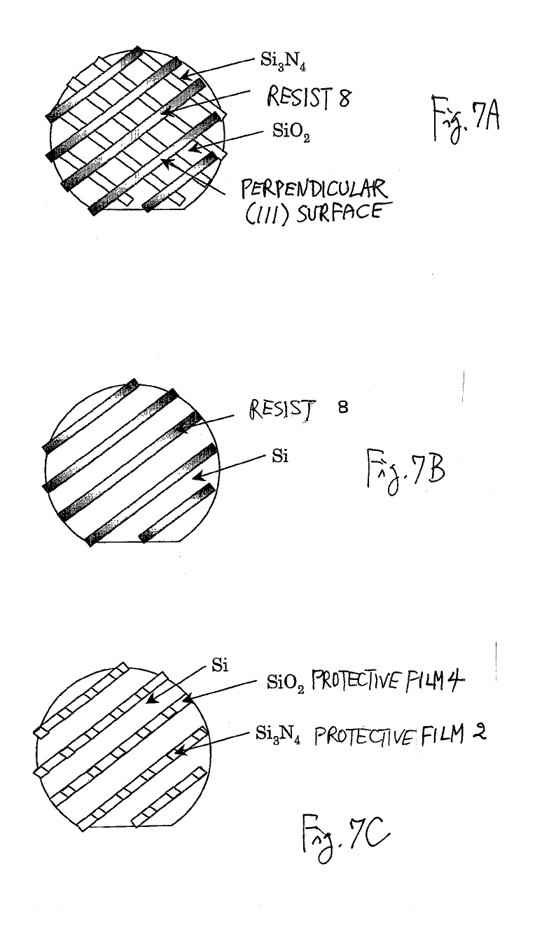

Step 7 is for resist patterning according to the other of the perpendicular (111) surfaces. As shown in FIG. 7A, a plurality of strips of resist 8 are patterned on the other of the perpendicular (111) surfaces. The alignment method is the same as that used in the first production method described above.

Step 8 is for removing the protective film on the silicon surface. As shown in FIG. 7B, the protective (Si₃N₄) film 2 and the protective (SiO₂) film 4 are removed, for example, by ion etching with the resist 8 used as a mask.

Step 9 is for removing the resist and exposing the silicon surface. Next, as shown in FIG. 7C, the resist 8 is removed. As a result, a plurality of belt-like portions appear where the resist 8 was, the protective (Si₃N₄) film 2 and the protective (SiO₂) film 4 alternately arranged on these belt-like portions.

In summary, SiO₂ and Si₃N₄ will appear alternately on the belt-like portions respectively as the protective film 2 and the protective film 4, as a result of Steps 4-9. This is done because the protective (Si₃N₄) film 2 is to be removed to expose the silicon surface in Step 12 and incisions are to be made in Step 13 on the exposed portions of the silicon according to one of the perpendicular (111) surfaces.

Steps 4-9 described above are advantageous because a mask can be formed with the silicon wafer 1 in a flat condition, aligned to two perpendicular (111) surfaces, that is, the formation of a mask becomes easier. For coating a wall with steps as high as several hundred μm with a resist for patterning, for example, it will be necessary, say, to apply a thick-film resist. Application of a resist alone may be relatively simple because the use of the spray coating method may be possible, but the exposure to light may be a different matter because light may not reach the bottom of a deep groove for exposure. Thus, the present method according to this invention is advantageous, being capable of forming a mask material according to two mutually perpendicular (111) surfaces, while the wafer surface is kept in a flat condition.

Although the second method is described above as forming the protective (Si₃N₄) film 2 first in Step 1, the protective (SiO₂) film 4 may be formed first before the formation of the protective (Si₃N₄) film 2. In this way, the protective (SiO₂) film 4 will appear in Step 5 where the silicon is appearing and hence the patterning of Step 7 may be directly carried out. In other words, the same configurations as by Step 6 can be obtained also by first forming the protective (SiO₂) film 4.

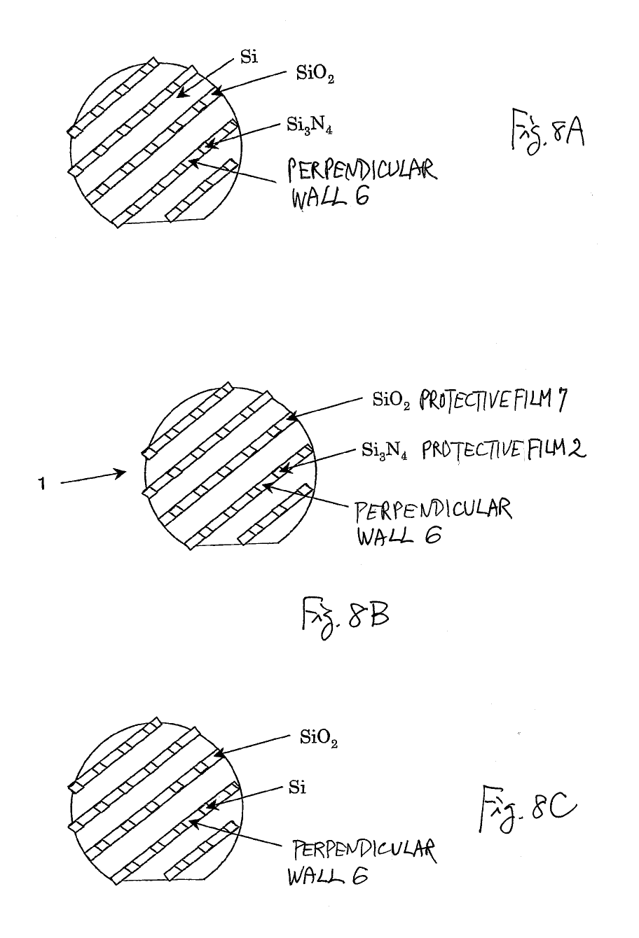

Step 10 is for the primary anisotropic etching of the silicon surface. As shown in FIG. 8A, perpendicular walls 6 are formed by digging down the silicon surface by crystalline anisotropic etching. By the etching in this step, the belt-like portions of the protective films 2 and 4 are not etched and the portions of the silicon surface adjacent to the protective films 2 and 4 are dug, the belt-like portions where the protective films 2 and 4 are formed being formed into the perpendicular walls 6. The side surfaces of the perpendicular walls 6 become perpendicular to each other because the surfaces of the perpendicular walls 6 are one of the two (111) surfaces which are perpendicular to the (110) surface of the wafer surface.

Step 11 is for forming a protective film on the perpendicular walls. As shown in FIG. 8B, an oxide (SiO₂) film is formed as a protective film 7 by thermal oxidation of the entire wafer 1. As a result of this step, the protective film 7 comes to be formed both on the top surface and the side surfaces of the perpendicular walls 6. In other words, this step is for forming the mask material for the secondary anisotropic etching to be carried out later.

Step 12 is for partially removing the protective film on the upper surface of the perpendicular walls 6. As shown in FIG. 8C, the protective (Si₃N₄) film 2 on the upper surface of the perpendicular walls 6 is removed by etching. This may be carried out by RIE. The purpose of this step is to remove these portions by the secondary anisotropic etching.

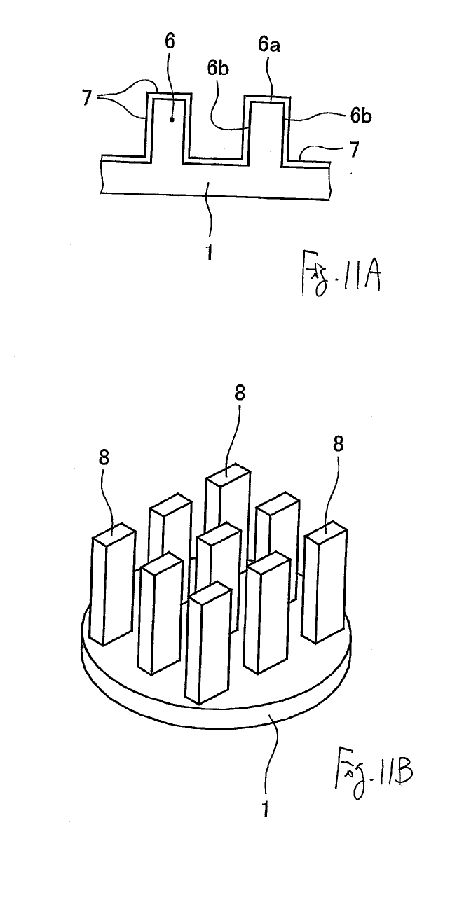

Step 13 is for cutting the perpendicular walls 6. As shown in FIG. 9A, incisions are made where the protective film 2 was removed from the perpendicular walls 6. Any means may be used for the cutting such as a dicing saw or a laser. The purpose of making such incisions is to prevent etch stops on other sloped (111) surfaces such that the etching will proceed to the perpendicular surface. If no incisions were made, sloped (111) surfaces would appear, as shown in FIG. 12A, and if they cross each other at a bottom, the etching would stop at such a point and the etching process would not proceed any further. If incision traces 10 are formed longitudinally, as shown in FIG. 12B, the etching process will proceed sideways and an etch stop takes place at the appearance of a perpendicular (111) surface, as shown in FIG. 12C. It is a necessary condition for producing a prismatic shape to have this perpendicular (111) shape exposed.

Step 14 is for the secondary anisotropic etching of the silicon surface. As shown in FIG. 9B, the secondary anisotropic etching step is finally carried out with TMAH. As a result of the etching in this step, the silicon surface is dug at positions where incisions were made on the perpendicular walls 6, and the side surface portions where the incisions were made are formed perpendicularly along the crystalline (111) surface. This is because the wall surface of the perpendicular wall 6 is the other of the two (111) surfaces which are perpendicular to the (110) surface on the wafer. Since the protective film 7 is attached to the formed wall surface of the perpendicular wall 6, the side walls can be prevented from being abraded at the time of the secondary anisotropic etching. For this reason, only the surfaces crossing the side wall with the protective film formed are etched by the secondary anisotropic etching and hence the prismatic shape is completed at the time of the etch stop on the (111) surface of the side wall. The protective (SiO₂) film 7 remains on the top surface of the perpendicular walls 6.

As a result of the secondary anisotropic etching, silicon in prismatic shape can be obtained with the protective film 7 remaining on the top surface.

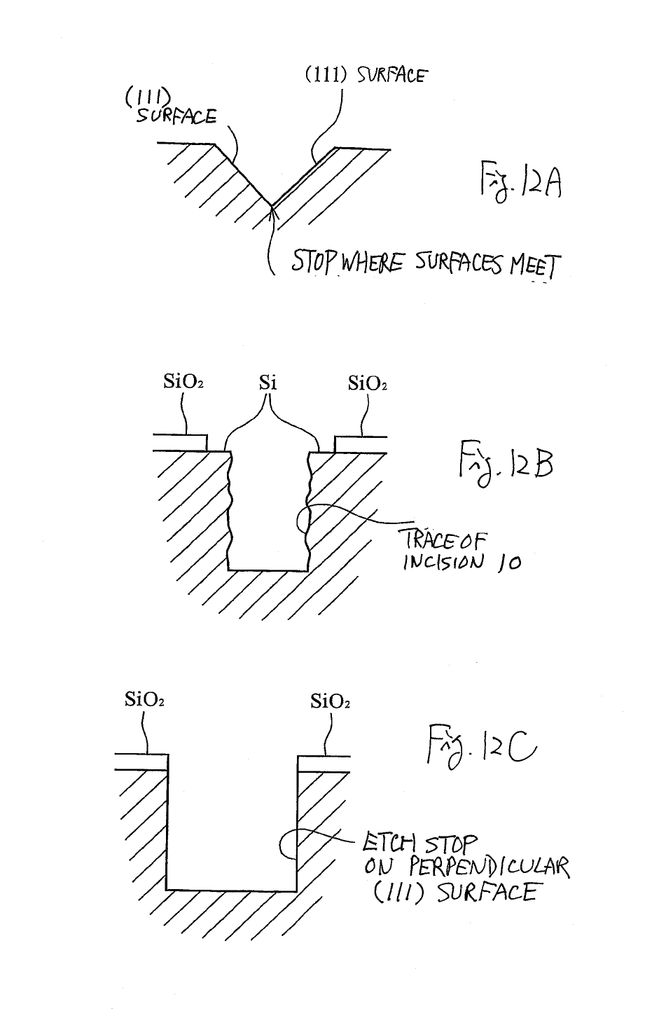

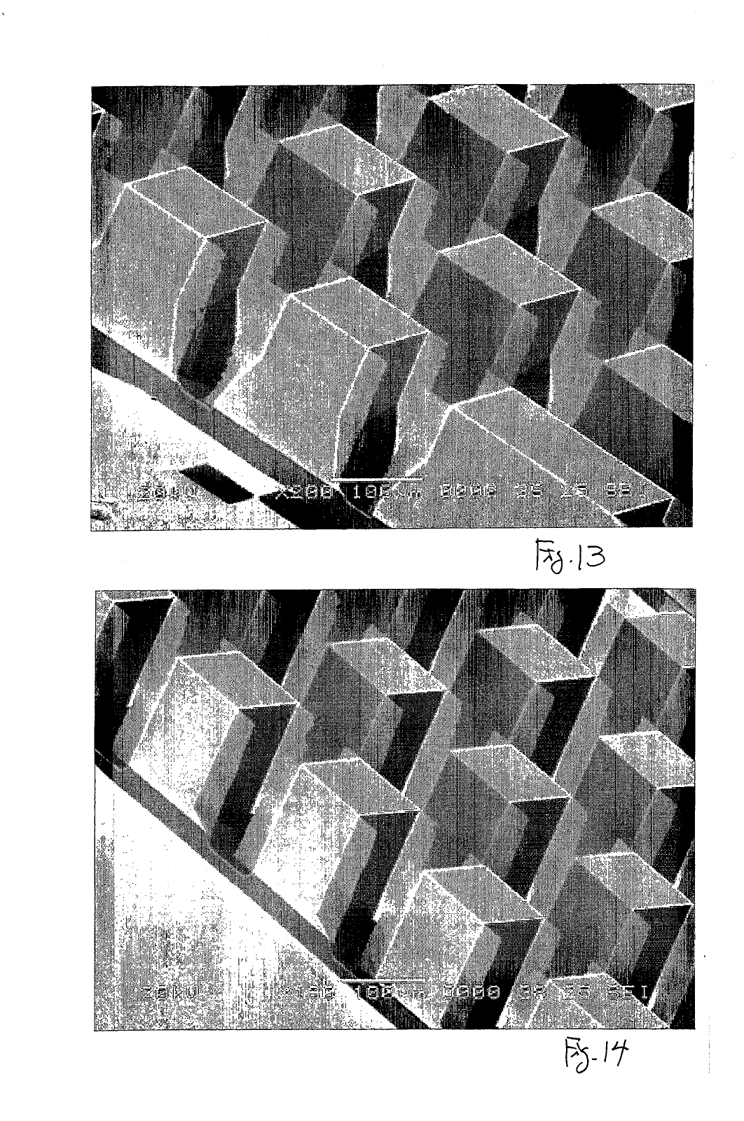

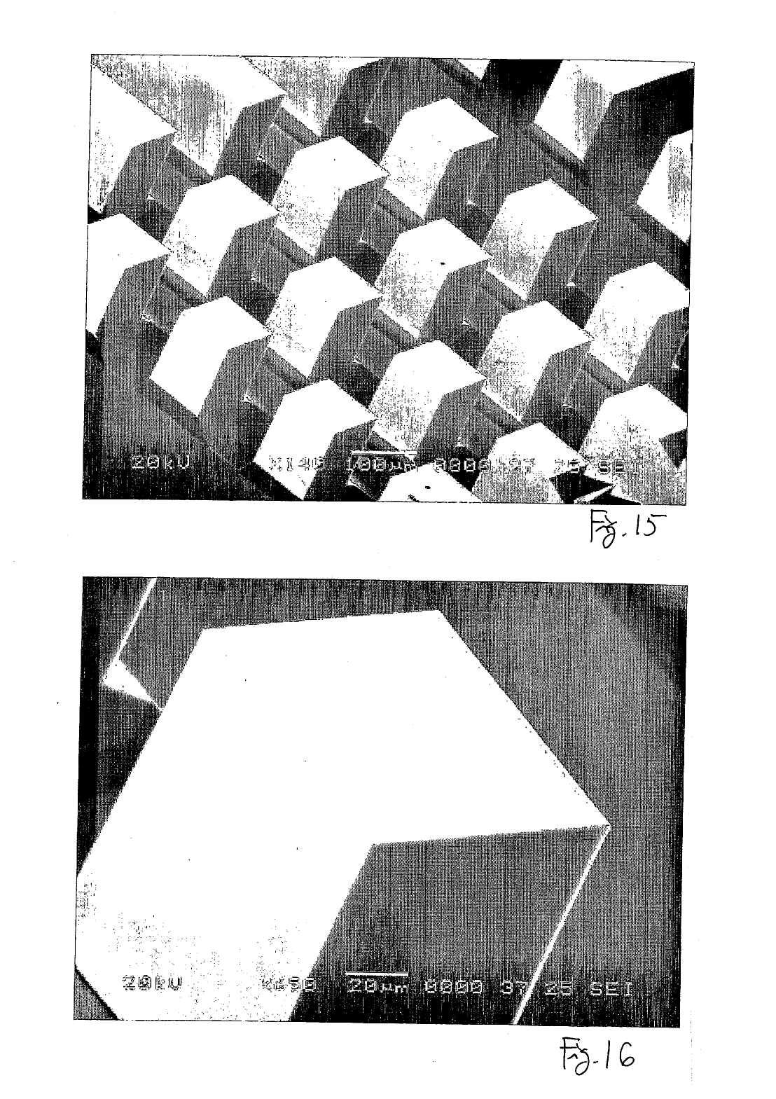

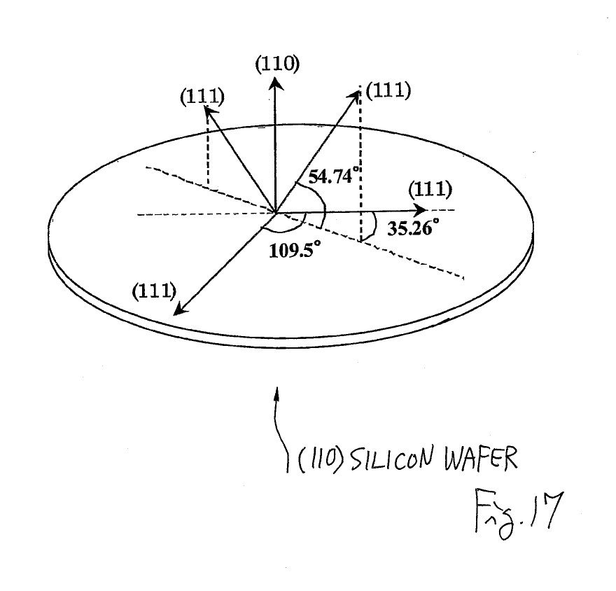

FIG. 13 is an SEM photograph of the prisms obtained by continuing the secondary anisotropic etching for 30 minutes, FIG. 14 is an SEM photograph after one hour, FIG. 15 is an SEM photograph after the etching was completed and the oxide film has been removed, and FIG. 16 is an enlarged photograph of a portion of FIG. 15.

Under the conditions of FIG. 13, inclined surfaces still remain near the bottoms of the prismatic shapes that are being formed and a thin oxide film is still attached to the side surfaces. Under the conditions of FIG. 14, the slopes near the bottoms of the prisms are nearly gone. FIG. 15 shows that clear prismatic shapes are already formed. Under this clearly formed condition, FIG. 16 shows that the side surfaces of the prismatic shapes are very smoothly finished.

Step 15 is for removing the oxide film. As shown in FIG. 9C, silicon prisms 8 appear as the protective (SiO₂) film 7 is removed. As shown in FIG. 11B, there are a plurality of such silicon prisms 8 seen standing up.

The second production method of this invention, as described above, has the following advantages.

Firstly, silicon in prismatic shape can be obtained with a (110) surface as the top surface and (111) surfaces as side surfaces because a silicon wafer with a (110) surface is used and etched such that two (111) surfaces perpendicular to the substrate surface inside will appear.

Secondly, perpendicular (111) surfaces can be dug out accurately and silicon in prismatic shape having side surfaces accurately made perpendicular to the top surface can be obtained because the etching is carried out after alignment configurations having two perpendicular (111) surfaces are formed and both the primary anisotropic etching with alignment to one of these two (111) surfaces and the secondary anisotropic etching with alignment to the other of these two (111) surfaces are carried out.

Thirdly, no particular method is necessary for the coating of resist or for the exposure to light because the protective film forming step can be carried out prior to the formation of the perpendicular walls 6 while the silicon surface is still flat.

Fourthly, the protective film 7 can be attached to the side walls of the perpendicular walls 6 formed by the primary anisotropic etching step since it is formed between the primary and secondary anisotropic etching steps. The side walls can thus be prevented from being abraded at the time of the secondary anisotropic etching. As a result, only the portions not having the protective film 7 are etched in the secondary anisotropic etching step and the prismatic shapes are formed at the moment of the etch stop at the (111) surface of these side walls. Thus, silicon prisms 8 having four accurately perpendicular (111) surfaces as side walls can be obtained.

Silicon in a prismatic form 8 obtained by the second production method of this invention is surrounded by four perpendicular (111) surfaces, and it can theoretically be formed in a shape with a high aspect ratio by the method of this invention.

To have four sides surfaces all comprising a (111) surface means that the condition of atomic bonding is stable and that there is no occurrence of burrs or chipping. Thus, even if silicon is made into a prismatic shape with a large height with respect to its cross-sectional area or with a high aspect ratio, it can be used widely in many applications.

All four side wall surfaces can also be made very smooth. This also serves to find many areas of application by utilizing the prismatic shape.

In summary, silicon in a prismatic shape according to this invention is characterized as having four side surfaces that are perpendicular to its top surface, and since the side surfaces are surrounded only by (111) surfaces, they are prism-shapes with no burrs or chipping. Thus, prisms with a high aspect ratio are possible and can be useful in many applications such as electrodes.

Silicon in a prismatic shape according to this invention can be useful in various industrial fields such as fabrication of mother dies for filters and high-density micro-electrodes but the fields of application are not limited by these examples.

What is claimed is:

1. A method of using a silicon wafer with (110) surface for producing silicon in a prismatic shape, said method comprising sequentially carrying out:
an alignment configuration forming step for forming alignment configurations having surfaces that are along two (111) surfaces perpendicular to a substrate surface inside said silicon wafer;
a primary anisotropic etching step for forming perpendicular walls having wall surfaces aligned to one of said (111) surfaces; and
a secondary anisotropic etching step for forming silicon in said prismatic shape having wall surfaces aligned to the other of said (111) surfaces with respect to said perpendicular walls.

2. A method of using a silicon wafer with (110) surface for producing silicon in a prismatic shape, said method comprising sequentially carrying out:
an alignment configuration forming step for forming alignment configurations having surfaces that are along two (111) surfaces perpendicular to a substrate surface inside said silicon wafer;
a primary anisotropic etching step for forming perpendicular walls by carrying out an anisotropic etching process on said silicon wafer with resist patterning aligned to one of said (111) surfaces such that said one (111) surface becomes a perpendicular wall surface;
a protective film forming step for forming a protective film on surfaces of said silicon wafer inclusive of said wall surface of said perpendicular walls; and
a secondary anisotropic etching step for forming silicon in said prismatic shape by carrying out an anisotropic etching process on said silicon wafer with resist patterning aligned to the other of said (111) surfaces such that portions of said perpendicular walls become said other (111) surface and a perpendicular wall surface.

3. A method of using a silicon wafer with (110) surface for producing silicon in a prismatic shape, said method comprising sequentially carrying out:
an alignment configuration forming step for forming alignment configurations having surfaces that are along two (111) surfaces perpendicular to a substrate surface inside said silicon wafer;
a pattern forming step for forming a first resist pattern along one of said (111) surfaces and a second resist pattern on said first resist pattern along the other of said (111) surfaces;
a primary anisotropic etching step for forming perpendicular wall surfaces to said first resist pattern by digging on said silicon wafer between mutually adjacent ones of said first resist pattern by anisotropic etching;
a protective film forming step for forming a protective film entirely over said silicon wafer inclusive of side wall surfaces of said perpendicular walls;
an incision step for cutting a silicon surface underneath said second resist pattern on said perpendicular walls; and
a secondary anisotropic etching step for forming silicon in said prismatic shape having a portion with said first resist pattern as top surface by digging on said silicon wafer by crystalline anisotropic etching.

4. Silicon in a prismatic shape, having a (110) surface as a top surface and four side surfaces that are (111) surfaces and perpendicular to said top surface.

5. The silicon of claim 4 produced by a method using a silicon wafer with (110) surface, said method comprising sequentially carrying out:
an alignment configuration forming step for forming alignment configurations having surfaces that are along two (111) surfaces perpendicular to a substrate surface inside said silicon wafer;
a primary anisotropic etching step for forming perpendicular walls by carrying out an anisotropic etching process on said silicon wafer with resist patterning aligned to one of said (111) surfaces such that said one (111) surface becomes a perpendicular wall surface;
a protective film forming step for forming a protective film on surfaces of said silicon wafer inclusive of said wall surface of said perpendicular walls; and
a secondary anisotropic etching step for forming silicon in said prismatic shape by carrying out an anisotropic etching process on said silicon wafer with resist patterning aligned to the other of said (111) surfaces such that portions of said perpendicular walls become said other (111) surface and a perpendicular wall surface.

6. The Silicon of claim 4 produced by a method using a silicon wafer with (110) surface, said method comprising sequentially carrying out:
an alignment configuration forming step for forming alignment configurations having surfaces that are along two (111) surfaces perpendicular to a substrate surface inside said silicon wafer;
a pattern forming step for forming a first resist pattern along one of said (111) surfaces and a second resist pattern on said first resist pattern along the other of said (111) surfaces;
a primary anisotropic etching step for forming perpendicular wall surfaces to said first resist pattern by digging on said silicon wafer between mutually adjacent ones of said first resist pattern by anisotropic etching;
a protective film forming step for forming a protective film entirely over said silicon wafer inclusive of side wall surfaces of said perpendicular walls;
a cutting step for cutting a silicon surface underneath said second resist pattern on said perpendicular walls; and
a secondary anisotropic etching step for forming silicon in said prismatic shape having a portion with said first resist pattern as top surface by digging on said silicon wafer by crystalline anisotropic etching.
